(19) United States
(12) Patent Application Publication
(10) Pub. No.: US 2005/0060335 A1
(43) Pub. Date: Mar. 17, 2005

(54) Product conversion and documentation process

(75) Inventor: Paul L. Klassy, Eagan, MN (US)

Correspondence Address: EATON CORPORATION;EATON CENTER, 1111 SUPERIOR AVENUE, CLEVELAND, OH, 44114, US

(73) Assignee: EATON CORPORATION, Cleveland, OH (US)

(21) Appl. No.: 10/660,923

(22) Filed: Sep. 12, 2003

(51) Int. Cl. G06F 17/00

(52) U.S. Cl. 707/102

(57) ABSTRACT

A method of converting an original product (11) into a modified product (31) and documenting the conversion, the original product (11) including a product label (23) including at least one item of permanent information (27), and at least one item of information (29) unique to the original product (11). The method of converting and documenting comprising the steps of converting the original product (11) into the modified product (31), and then applying over the product label (23) a conversion label (43). The conversion label (43) defines a cut-out portion (45) disposed to permit viewing of the one item of permanent information (27) on the original product label (23) The final step is applying to the conversion label (43) at least one item of information (47) unique to the modified product (31).

### BACKGROUND OF THE DISCLOSURE

The present invention relates to products of the type which are likely to be converted or modified into a different product model between the time of original manufacture and the eventual sale and use of the product, and more particularly, to a process for documenting the conversion or modification of the product, and identifying the converted product as a different product model.

Although it will become apparent from a reading and understanding of the subsequent specification that the method of converting a product, and then documenting such a conversion, can be applied to many different types of products, it is especially well suited with, and advantageous for use in connection with hydraulic motors, and will be described in connection therewith, by way of example and illustration only.

Hydraulic motors, and especially low speed, high torque (LSHT) gerotor motors, of the type made by the assignee of the present invention, can have many different product configurations, and it is typically desirable that each different, separate product configuration have its own unique product identification code or model number. As will be described in greater detail subsequently, examples of the different product configurations typically available on a LSHT gerotor motor would include a choice between perhaps four different mounting flange types, and a choice among as many as fifty different output shaft types. In view of the fact that each mounting flange type can be used with each output shaft type, just the choices noted above, without consideration of any other product options (such as port size, port location, etc.), could result in two hundred different product models. Then, when consideration is also given to various other product options, it may be seen that the total number of different, separate product models can quickly run into the many hundreds and even thousands. The present invention is especially well suited for use with any type of product having the potential for such a multiplicity of product models.

Prior to the present invention, it has been common practice for gerotor motor manufacturers to ship quantities of the various, more common motor configurations (“models”) to their motor distributors, who would stock these particular motor configurations in their inventory system, and sell them to end customers upon request for those particular motor configurations. Unfortunately, when the distributor would receive a request from a potential customer for a different product configuration, it has been common practice for the distributor to request, from the motor manufacturer, the required volume of motors having the particular, requested configuration. The process operates in the manner indicated especially in regard to relatively lower volume motor configurations.

Typically, upon receiving from a distributor a request for one of these less common motor configurations, the motor manufacturer would prepare certain documentation unique to that requested motor configuration, including drawings (both installation drawings and any unique individual component drawings); a bill of materials (“parts list”), as well as all other documents needed in connection with raw material procurement, inventory management, testing, pricing, and shipping and invoicing. The result of the above-described method of providing this particular (typically, low volume) motor configuration would be substantial overhead expense and a delay of perhaps several days to several weeks in being able to provide the desired motor product configuration to the end customer.

At the same time that the above-described process is being followed in order to provide certain lower volume motor configurations to customers, the motor distributors are dealing with another, somewhat opposite problem. Over a period of time it has been determined that a certain percentage (hopefully no more than about 2 or 3%) of the motors in the distributor's inventory are not sold within a reasonable time and are eventually returned to the motor manufacturer. Those motors which are returned to the motor manufacturer are then either sold to another distributor who has expressed a need for that particular motor configuration, or are rebuilt by the manufacturer and sent back to the distributor (who originally had the “returned” motor) in a motor configuration more in line with current customer needs of that distributor.

Prior to the present invention, it has been common practice by the assignee of the present invention to apply to its gerotor motor products a product identification tag (or label) which bears a number of items of information, including the original date of manufacture, the product identification code (which is like a “serial number”), and a model number (which “defines” all of the features of that particular motor model). The date of manufacture is an important item of information, especially in the event of any sort of later warranty or field return situation, because the warranty offered by the motor manufacturer (and product manufacturers in general) is typically a fixed period of time (for example, three years), figured from the date of manufacture on the product tag. It has also been common practice that any modification of the product (from the configuration indicated by the original product code or model number on the product tag) would have the effect of voiding the warranty.

It may be seen that the above-described procedures for handling product conversions, especially taken together with various other policies noted above, may not always result in the most efficient way of getting into the hands of the end customers the particular motor configurations which they need at any particular time. Furthermore, the process described above involves a substantial amount of generally unproductive and expensive documentation, shipment and handling of motors and parts therefor, in order to finally provide the customer with the desired motor model.

### BRIEF SUMMARY OF THE INVENTION

Accordingly, it is an object of the present invention to provide an improved method of converting an original product into a modified product, and documenting the conversion, which overcomes at least most of the shortcomings discussed above, associated with a typical product conversion process.

It is a more specific object of the present invention to provide an improved product conversion and documentation method which accomplishes the above-stated object, and which permits the conversion process to be accomplished by someone other than the original product manufacturer, such as the product distributor.

It is another object of the present invention to provide such an improved product conversion and documentation process which accomplishes the above-stated objects, while insuring that the converted (or modified) product bears whatever information is required to be on that product, even after the conversion to a different product model.

Finally, it is a separate, but related, object of the present invention to provide such an improved product conversion and documentation process which is readily compatible with the needs of the inventory control process, for at least the entity performing the product conversion and documentation.

The above and other objects of the invention are accomplished by the provision of an improved method of converting an original product into a modified product, the original product having a product label including at least one item of permanent information, and at least one item of information unique to the original product.

The improved method of converting comprises the steps of: (a) converting the original product into the modified product; (b) applying over the product label a conversion label, the conversion label defining a cutout portion disposed to permit viewing of the one item of permanent information on the product label; and (c) applying to the conversion label at least one item of information unique to the modified product.

### BRIEF DESCRIPTION OF THE DRAWINGS

FIG. 1 is a perspective view of an example of an original product of the type to which the method of the present invention would be applicable.

FIG. 2 is a perspective view, similar to FIG. 1, but illustrating an example of a modified product resulting from the method of the present invention.

FIG. 3 is a plan view of an original product label, of the type which would be on an original product prior to conversion, in accordance with the method of the present invention.

FIG. 4 is a plan view of a conversion label which comprises one important aspect of the present invention, and on the same scale as FIGS. 3 and 5.

FIG. 5 is a plan view of a final product label associated with the modified product, in accordance with the method of the present invention.

### DETAILED DESCRIPTION OF THE PREFERRED EMBODIMENT

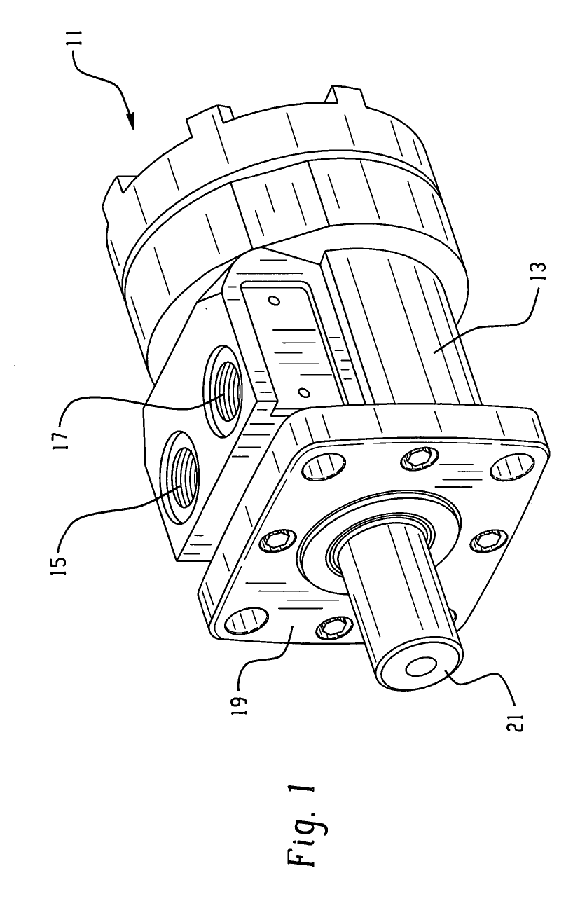

Referring now to the drawings, which are not intended to limit the invention, FIG. 1 is a perspective view of a LSHT gerotor motor, generally designated 11, of a type which is well known to those skilled in the art, and which is sold commercially by the assignee of the present invention. In connection with the explanation of the present invention, the motor 11 is an example of an “original product” and for purposes of subsequent description, it will be assumed that this original product is in the inventory of the distributor who sells motors of this general type to various ultimate end customers, some of whom would order a volume of motor models exactly as shown in FIG. 1. However, as was explained in the BACKGROUND OF THE DISCLOSURE, certain end customers will order a volume of motor models which differ somewhat from the “original product” shown in FIG. 1.

In view of the fact that motors of the type shown herein are well-known, and are commercially available in many configurations, the subsequent description will recite only those elements necessary in order to illustrate and describe the conversion method of the present invention. The motor 11 includes a motor housing 13 which defines a pair of fluid ports 15 and 17. Adjacent the motor housing 13 is a generally square four-bolt mounting flange 19, typically bolted to the motor housing 13. Rotatably disposed within, and extending forwardly from, the mounting flange 19 is the motor output shaft 21 which, in this particular motor configuration, comprises a conventional straight shaft. As is well known to those skilled in the art, if the fluid port 15 is the inlet port, and receives pressurized fluid, the output shaft 21 rotates in one direction (e.g., clockwise as viewed in FIG. 1), whereas if the fluid port 17 is the inlet port, and receives pressurized fluid, the output shaft 21 rotates in the opposite direction (counterclockwise in this example).

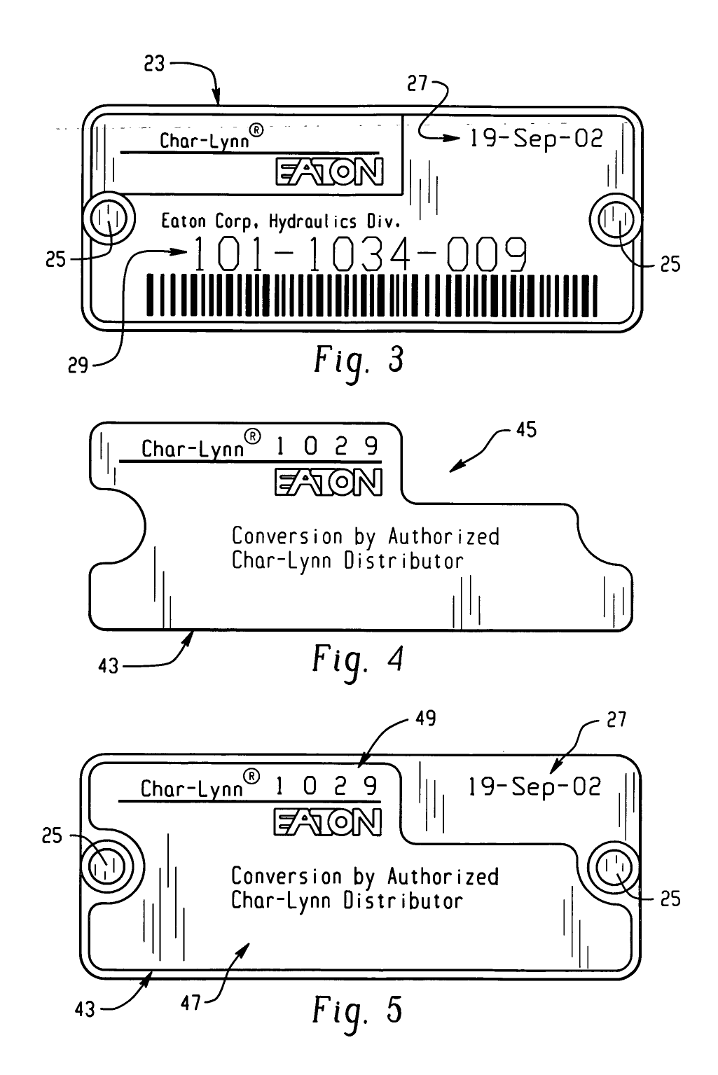

Referring now primarily to FIG. 3, there is an illustration of a product label, generally designated 23, which would typically be attached to the motor housing 13 (in the depression just under the port 17 in FIG. 1) by means of a pair of rivets 25, or any other suitable fasteners or means of attachment. Alternatively, the product label 23 has sometimes been attached to the port face, adjacent the ports 15 and 17. It should become clear to those skilled in the art, from a reading of the subsequent specification, that the configuration of the product label 23, the material from which it is made, the kind of information contained on the label, and the method of attaching the label to the original product are not essential features of the invention. Instead, those configurations, features and method steps which are essential to the invention will be noted herein subsequently, and in the appended claims.

The product label 23 includes several different types of information. In the upper left-hand corner of the label 23 is, by way of example only, a designation of the assignee of the present invention who is the manufacturer of the original product, this designation including, merely by way of example, two registered trademarks of the assignee of the present invention, one of which is broadly associated with the assignee, and the other of which is more specifically associated with the business unit within the assignee which manufactures products such as the motor 11.

In the upper right-hand corner of the product label 23 is “an item of permanent information”, generally designated 27, which, in the subject embodiment and by way of example only, comprises the original date of manufacture of the motor 11. For this particular item of product, the date of manufacture as shown is “19 Sep. 2002” (i.e., Sep. 19, 2002). As was mentioned in the BACKGROUND OF THE DISCLOSURE, the date of manufacture is an example of an item of information which is important, and needs to remain visible, even if the motor 11 is later modified, for warranty purposes.

On the lower half of the product label 23 is an item of information, generally designated 29, which is unique to the original product. In the subject embodiment, and by way of example only, the item of information 29 comprises a ten digit model code (“101-1034-009”) which is representative of the product configuration for the motor 11, as shown in FIG. 1. In other words, the motor manufacturer could, when presented with only the model code shown in FIG. 3, provide the motor 11 shown in FIG. 1.

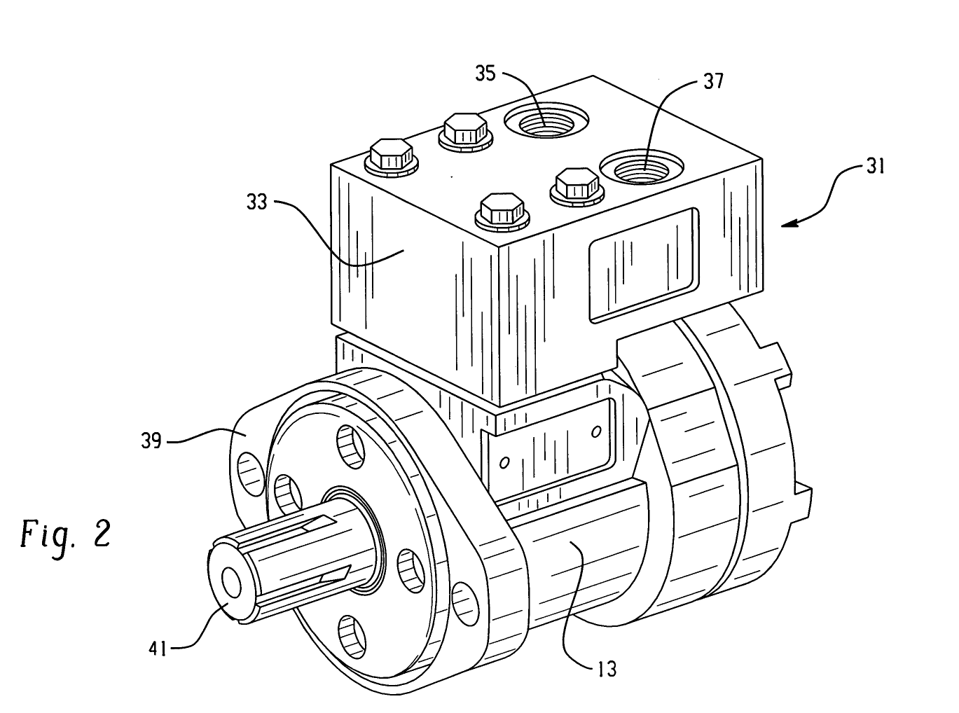

Referring now primarily to FIG. 2, there is illustrated a gerotor motor 31, which, for purposes of the subsequent description, is an example of a “modified product”. The modified motor 31 has a port block valve assembly 33 bolted to the upper surface of the motor housing 13, which in the present example is the same housing shown in the original motor 11. The port block valve assembly 33 is preferably bolted to the housing 13, and defines a pair of fluid ports 35 and 37, which function in the same manner as the fluid ports 15 and 17 previously described. In the modified motor 31, the four-bolt mounting flange 19 is removed, and replace by a two-bolt mounting flange 39. As is well known to those skilled in the art, the type of mounting flange used on the LSHT gerotor motor depends, typically, on the surrounding structure and how the motor is to be mounted within the vehicle, or other piece of equipment.

At the same time that the mounting flange 19 is being replaced by the mounting flange 39, the output shaft 21 is also being replaced, and in this example, by a splined motor output shaft 41. As is also well known to those skilled in the art, the type of output shaft utilized on a gerotor motor is determined primarily by the configuration of the item (not shown herein) being driven by the motor 31. For example, the item being driven by the motor 31 has in internally-splined hub, adapted to receive the externally-splined output shaft 41. Thus, the original motor 11 of FIG. 1 has been modified (or converted) into the modified motor 31 of FIG. 2. It should be understood that, for purposes of the present invention, a product “conversion” (or modification) can involve any one or more of the following : adding a part; subtracting a part; or substituting a new part for an old (“original”) part. In addition, the conversion process includes the “documentation” of the conversion, as will now be described.

In accordance with an important aspect of the present invention, after the product conversion is completed, resulting in the modified motor 31, the conversion is documented. A conversion label, generally designated 43, and shown in FIG. 4 is provided, and applied over the original product label 23, in the manner illustrated in FIG. 5. In the subject embodiment, and by way of example only, the conversion label 43 is a thin metal label or tag having an appropriate adhesive layer (not shown herein) on the rearward surface thereof, for application over the original product label 23 as shown in FIG. 5. However, within the scope of the present invention, the conversion label 43 may be applied over the original product label 23 by any suitable means. As may be seen by viewing FIGS. 3, 4 and 5 together, the conversion label 43 is preferably configured such that it does not interfere with the rivets 25, or whatever fastener means has been utilized to attached the product label 23. In the upper left-hand corner of the conversion label 43 there is substantially the same source identification information (trademarks) as on the original product label 23, although it should be apparent that the present invention is not so limited.

It may be seen in FIG. 4 that the conversion label 43 defines a cut-out portion 45 disposed such that, after the conversion label 43 is applied, the item of permanent information 27 (in this case, the date of original manufacture) still is visible. It should be understood that, within the scope of the present invention, the cut-out portion 45 does not have to literally be “cut-out” during the manufacture of the conversion label 43. The term “cut-out portion” is used in regard to the portion 45 simply to make it clear that the configuration of the conversion label 43 should be such that the item of permanent information 27 is still visible, after the conversion label 43 is applied. Thus, if desirable by the motor manufacturer, the original product warranty, which extends from the date shown as the “item of permanent information”, will continue even after the product conversion, as though the original motor 11 had never been modified. In utilizing the present invention with other products, there may be other items of permanent information which must continue to be visible after the product conversion, and for different reasons. Also, there may be many different configurations of the conversion label 43 and of the cut-out portion 45, all of which are intended to be included within the scope of the invention, insofar as they come within the scope of the appended claims.

Preferably, the conversion label 43 includes an area, generally designated 47, on which would typically be placed an item of information (also bearing the reference numeral “47”) which is unique to the modified product, i.e., the modified or converted motor 31. Normally, if the item of information 29, unique to the original motor 11 were an identification code, or a model number, the item of information 47 would also be an identification code or a model number. However, the model number to be placed in the area 47 will, in accordance with the invention, be that of the modified motor 31. It should be noted that, preferably, the conversion label 43, as provided to the entity who will convert the product, is a “generic” label, including only those items of information which will never (or almost never) change.

In the subject embodiment, one of those items is a statement (“Conversion by Authorized Char-Lynn Distributor”) indicating that the conversion has been performed by one who is authorized to do so. In addition, there is provided an item of information 49 (in this example, the number “1029”) which is like a serial number for the conversion label 43. Typically, the motor manufacturer would provide the authorized distributor with a package of the conversion labels 43, and would record the range of numbers represented by all of the labels in that package, thus being able later to determine that a particular product modification was, in fact, performed by that authorized distributor.

Therefore, in the preferred conversion and documentation process, the item of information 47 unique to the modified motor 31 is placed on the conversion label 43, at the time the conversion (from the motor 11 to the motor 31) is made, rather than at the time the label 43 is made, in order to provide the desired flexibility in the overall conversion process. In other words, at the time the conversion label 43 is produced, and even at the time the distributor purchases a package of the labels 43, no one knows what will be the configuration of the eventual modified product on which the conversion label 43 will be used.

In accordance with another aspect of the documentation method, it is considered desirable to utilize the conversion and documentation process of the present invention to at least initiate the appropriate updates of the inventory system. For example, and by reference to the motor conversion illustrated in FIGS. 1 and 2, when the authorized distributor performs the conversion from the original motor 11 to the modified motor 31, one of the changes is the addition of the port block valve assembly 33. When the new product identification code is placed in the area 47 on the conversion label 43, that new product identification code will inherently indicate that the modified motor 31 now includes one of the port block valve assemblies 33. Therefore, as one preferred, but not essential, step in the documentation process, when the new product identification code is placed on the label 43, the distributor's inventory system should then be updated, by decrementing the distributor's inventory count for port block valve assemblies 33.

At the same time, and by way of example, the four-bolt mounting flange 19 has been removed and replaced by the two-bolt mounting flange 39. Thus, the distributor's inventory count should, at that time, be updated by incrementing the inventory count for four-bolt mounting flanges 19 (because the one removed in the conversion process should be placed in inventory and used later, when needed), and decrementing the inventory count for two-bolt mounting flanges 39 (because one has been removed from inventory to accomplish the conversion). The same is true, in the example provided herein in FIGS. 1 and 2, with regard to the motor output shaft 21 (the “old” part removed in the conversion), and the motor output shaft 41 (the “new” part substituted for the old part during the conversion). There are a number of different ways which can be utilized to achieve the inventory up-date, in conjunction with the generation of the item of information 47 which is unique to the modified product 31. A detailed discussion of the various ways for achieving the inventory up-date is beyond the scope of the present specification, although those skilled in the art will recognize that, at least initially, and on a small scale, such updates may simply be performed manually.

Those skilled in the art will understand that, even with regard specifically to LSHT gerotor motors, there are a number of other possible conversions, and the invention is not limited to any particular conversion. Furthermore, the conversion and documentation process of the present invention is clearly not limited to only gerotor motors, or to hydraulic products in general, but instead, can be utilized in connection with any product that typically goes through the types of conversion and modification processes described hereinabove, and for which it is desirable to be able to identify the new, modified product, while retaining at least on item of information present on the original product label.

The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

1. A method of converting an original product into a modified product and documenting said conversion, the original product including a product label including at least one item of permanent information, and at least one item of information unique to said original product, said method comprising the steps of:
(a) converting said original product into said modified product;
(b) applying over said product label a conversion label, said conversion label defining a cut-out portion disposed to permit viewing of said one item of permanent information on said original product label; and
(c) applying to said conversion label at least one item of information unique to said modified product.

2. A method of converting an original product into a modified product and documenting said conversion, as claimed in claim 1, characterized by said one item of permanent information comprises a code representative of the date of manufacture of said original product.

3. A method of converting an original product into a modified product and documenting said conversion, as claimed in claim 1, characterized by said one item of information unique to said original product comprises an original product identification code representative of the configuration of said original product, and said item of information unique to said modified product comprises a new product identification code representative of the configuration of said modified product.

4. A method of converting an original product into a modified product and documenting said conversion, as claimed in claim 3, characterized by said step (a) of converting comprises the step of adding a new part to said original product to form said modified product, and including the further step of:
(d) utilizing said new product identification code to decrement an inventory count for said new part.

5. A method of converting an original product into a modified product and documenting said conversion, as claimed in claim 3, characterized by said step (a) of converting comprises the step of substituting for an old part of said original product a new part to form said modified product, and including the further step of:
(d) utilizing said original product identification code to increment an inventory count for said old part, and utilizing said new product identification code to decrement an inventory count for said new part.

6. A method of converting an original product into a modified product and documenting said conversion, as claimed in claim 1, characterized by said step (b) of applying said conversion label includes the step of adding to said conversion label an indication that the step (a) of converting has been performed by an entity who is authorized to perform such a conversion.

7. A method of converting an original product into a modified product and documenting said conversion, as claimed in claim 1, characterized by said conversion label is provided with an adhesive backing to facilitate application of said conversion label over said product label.

8. A method of converting an original product into a modified product and documenting said conversion, as claimed in claim 1, characterized by said product label being attached to said original product by means of a plurality of fasteners, and said conversion label is configured to avoid interference with said fasteners.
